(19) United States
(12) Patent Application Publication
(10) Pub. No.: US 2008/0005755 A1
(43) Pub. Date: Jan. 3, 2008

(54) ACTUATOR OF OPTICAL PICKUP HEAD

(75) Inventor: Pei-Ching Kuo, Hsinchu (TW)

Correspondence Address: WPAT, PC, 7225 BEVERLY ST., ANNANDALE, VA, 22003, US

(73) Assignee: LITE-ON IT CORP., Taipei (TW)

(21) Appl. No.: 11/616,859

(22) Filed: Dec. 28, 2006

(30) Foreign Application Priority Data
Jun. 28, 2006 (TW) 095123407

(51) Int. Cl. G11B 7/00

(52) U.S. Cl. 720/685; 369/44.15

(57) ABSTRACT

The actuator comprises of two magnetic elements, four metallic wires, a lens holder located between the two magnetic elements for holding a lens, and a planar coiling device affixed on the lens holder. The lens holder further comprises of at least one fixing part whose purpose is to connect with the four metallic wires and keep the lens holder at a hanging status. The planar coiling device further comprises of two focusing coils, two tracking coils and four separated bonding pads, two bonding pads located on each of the two surfaces of the planar coiling device for respectively connecting with the four metallic wires; two of the four bonding pads electrically connect to the two focusing coils and the other two bonding pads electrically connect to the two tracking coils.

### FIELD OF THE INVENTION

The present invention relates to an actuator of an optical pickup head, and more particularly to an actuator of an optical pickup head with horizontal-arranged magnetic field producing apparatus and coiling device.

### BACKGROUND OF THE INVENTION

Our world lives in the age of information outburst. Most media products are put in circulation in the forms of optical disks. The optical pickup head of an optical drive responsible for reading the information from or writing information onto an optical disk thus play an important role in today's optical storage technology.

Please refer to FIG. 1 to FIG. 3. FIG. 1 illustrates the overlooking view of an actuator of a conventional optical pickup head; FIG. 2 illustrates the lateral view, while FIG. 3 illustrates the three dimensional view. Actuator 100 of optical pickup head includes a lens holder (not shown), a magnetic field producing apparatus, a focusing coil 132 and tracking coils 134. The lens holder, normally made of non-magnetic conducting material, is used to carry one lens (illustrated with dotted line) 110, focusing coil 132 and tracking coils 134. Ordinarily, the lens holder is affixed and hung over metallic wires or leaf springs. When focusing coil 132 and tracking coils 134 oscillates vertically and horizontally under control the movement also causes oscillation of lens holder and the lens 110. Therefore, movement of the lens 110 is controlled and the light beam produced by a semiconductor laser through lens 110 can be focused at the correct position to enable the optical drive to write or read information from an optical disk.

The magnetic field producing apparatus is not in contact with the lens holder, lens 110, focusing coil 132, and the tracking coils 134; it is a permanently stationary apparatus in response to the lens holder. The magnetic field producing apparatus includes a first magnet 122, a first yoke 123, a second magnet 124 and a second yoke 125; the magnetic surface of the second magnet 124 faces the magnetic surface of the first magnet 122. The neighboring tracking coils 134 in between the first magnet 122 and the second magnet 124 are of the same polarity, i.e. they are either all N-or all S-polarity. Through the interaction between the first magnet 122 and the first yoke 123, and the interaction between the second magnet 124 and the second yoke 125, the magnetic field producing apparatus in between the magnets and yokes respectively produce a fixed-direction magnetic field.

Focusing coil 132 is placed between the first magnet 122 and the second magnet 124, the plane of focusing coil 132 is perpendicular to the magnetic surface of the first magnet 122 and the second magnet 124. When electric current runs through focusing coil 132, a first force is created by the interaction between focusing coil 132 and the above mentioned magnetic field which enables the lens holder to move along a focusing direction.

The tracking coils 134 are located in between the focusing coil 132 and the first magnet 122 and in between the focusing coil 132 and the second magnet 124; the plane of tracking coil 134 is parallel to the magnetic surface of the first magnet 122 and the second magnet 124. When electric current runs through tracking coils 134, a second force is created by the interaction between tracking coil 134 and the previously mentioned magnetic field; this second force then enables the lens holder to move along a tracking direction.

In a conventional actuator of optical pickup heads, in order to move the lens holder along the focusing and the tracking directions, product developing engineers need to devise a structural design for the first and second forces to be perpendicular with each other. This makes the coiling process of the focusing coil and tracking coil minute and complicated, increasing manufacturing time and production cost. For the same reason, the volume size and thickness of the conventional actuator of optical pickup head has been difficult to reduce, thereby limiting the application of optical pickup heads on small form factor optical disk drives (SFFO).

### SUMMARY OF THE INVENTION

Therefore, the present invention provides an actuator of an optical pickup head with horizontal-arranged magnetic field producing apparatus and coiling device having very thin thickness for used on small form factor optical disk drives (SFFO).

The present invention provides an actuator of an optical pickup head, comprising: two magnetic elements; a plurality of metallic wires; a lens holder connected to the metallic wires for hanging the lens holder and located the lens holder between the two magnetic elements; and a planar coiling device affixed on the lens holder and the coiling device including at least one focusing coil, at least one tracking coil and a plurality of separated bonding pads for electrically connecting to the metallic wires respectively; wherein two of the four bonding pads electrically connect to the at least one focusing coil and two bonding pads electrically connect to the at least one tracking coil.

The present invention further provides an actuator of an optical pickup head, comprising: a magnetic field producing apparatus including two magnetic elements; a hanging device including a plurality of electrically conducting elements; a lens holder connected to the hanging device for hanging the lens holder and located the lens holder between the two magnetic elements; and a planar coiling device affixed on the lens holder and the coiling device including at least one focusing coil, at least one tracking coil and a plurality of separated bonding pads for connecting to the electrically conducting elements respectively; wherein two of the four bonding pads electrically connect to the at least one focusing coil and two bonding pads electrically connect to the at least one tracking coil.

In one embodiment, the magnetic elements are magnets and each magnet comprises a plurality of magnetic areas.

In one embodiment, the planar coiling device is constructed by a print circuit board with a plurality of print circuit coils.

In one embodiment, the planar coiling device is constructed by a plastic substrate with a plurality of fine pattern coils.

In one embodiment, the at least one focusing coil and the at least one tracking coil are coiled into rectangular or circular shapes.

In one embodiment, two bonding pads are located on each of the two surfaces of the planar coiling device.

In one embodiment, the hanging device comprises a plurality of metallic wires or a plurality of leaf springs.

The above contents of the present invention will become more readily apparent to those ordinarily skilled in the art after reviewing the following detailed description and accompanying drawings, in which:

### BRIEF DESCRIPTION OF THE DRAWINGS

FIG. 1 shows an overlooking view of an actuator of a conventional optical pickup head;

FIG. 2 shows a lateral view of an actuator of a conventional optical pickup head;

FIG. 3 shows a three-dimensional view of an actuator of a conventional optical pickup head;

FIG. 4 shows an actuator of an optical pickup head according to the embodiment of the present invention;

FIG. 5 shows a lateral view of the actuator of optical pickup head according to the embodiment of the present invention;

FIG. 6 shows an overlooking perspective drawing of an actuator of optical pickup head according to the embodiment of the present invention;

FIG. 7 shows a movement of tracking coils when first current is being conducted; and

FIG. 8 shows a movement of focusing coils when second current is being conducted.

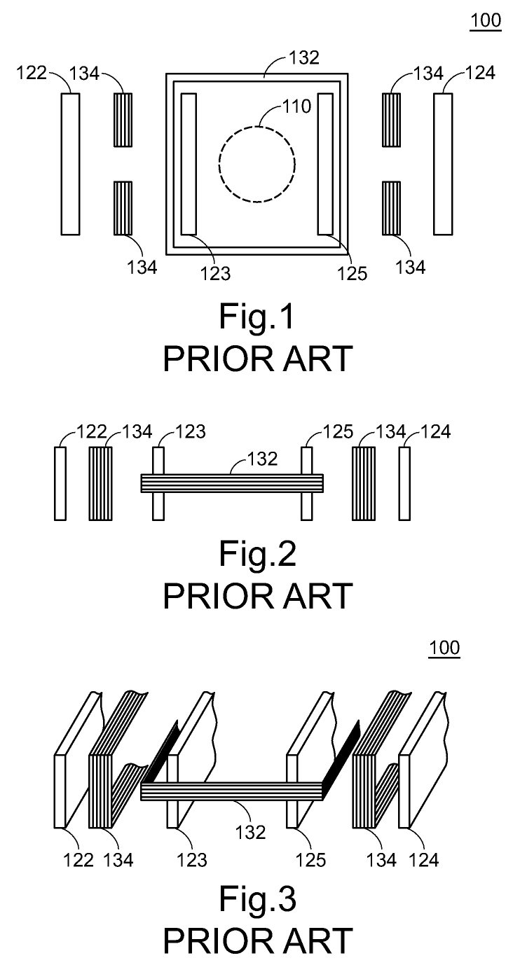

### DETAILED DESCRIPTION OF THE PREFERRED EMBODIMENT

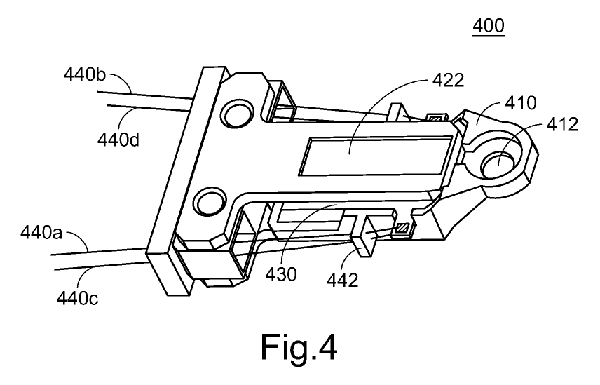

Please refer to FIG. 4 illustrating an actuator of an optical pickup head according to the embodiment of the present invention. The lens holder 410 of actuator 400 holds a lens 412 and a coiling device 430 including focusing coils and the tracking coils. Further, the hanging lens holder 410 is hung by a hanging device, such as metallic wires or spring leafs. As demonstrated in FIG. 4, the hanging device comprising four metallic wires 440a, 440b, 440c, 440d. The hanging device could further act as an electric current conducting wires that controls the focusing coils and the tracking coils. As shown in FIG. 4, it can be seen that two of the metallic wires are used to conduct current in and out of the focusing coils, while the other two wires are used to conduct current in and out of the tracking coils. The coiling device 430 is placed horizontally within the magnetic field producing apparatus, and a plurality of magnetic areas having different polarities are devised on the same magnetic surface of the magnetic field producing apparatus. Under such horizontal arrangement of the coiling device 430 and magnetic field producing apparatus magnets, lens holder 410 is prompted to move along the focusing and tracking directions. The actuator 400 with horizontal-arranged magnetic field producing apparatus and coiling device 430 would therefore be able to reduce the volume and thickness of an optical pickup head. Further, the horizontal arrangement in the present invention application is the plane that will be in parallel with the surface of an optical disk.

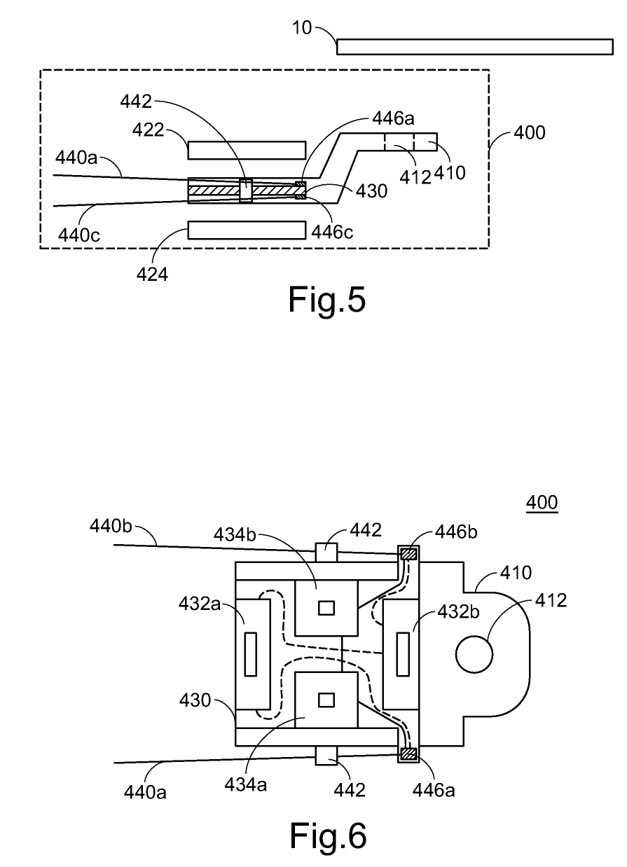

Please refer to FIGS. 5 and 6. FIG. 5 illustrates the lateral view of an actuator of an optical pickup head of the present invention while FIG. 6 illustrates an overlooking view. Actuator 400 is moved for reading or writing the information on the information tracks of an optical disk 10. Actuator 400 includes the lens holder 410, magnetic field producing apparatus and the coiling device 430. The design of lens holder 410 is hanging and is hung through connecting metallic wires 440a, 440b, 440c, and 440d.

The magnetic field producing apparatus is used to produce a first magnetic field and a second magnetic field. The magnetic direction of the first magnetic field is perpendicular to the surface of the optical disk 10; the magnetic direction of the second magnetic field is parallel to the surface of the optical disk 10. The magnetic field producing apparatus includes two magnetic elements such as the first magnet 422 and the second magnet 424; the first magnet 422 is horizontally placed above the lens holder 410 while the second magnet 424, corresponding to the first magnet 422, is placed horizontally below lens holder 410.

Coiling device 430 is horizontally placed and affixed on the lens holder 410, and it is constructed by fine pattern coils on a plastic substrate or a print circuit coils on a print circuit board; thus the coiling device 430 is a planar coiling device 430 with very thin thickness. On the coiling device 430 focusing coils 432a, 432b and tracking coils 434a, 434b can be formed; focusing coils 432a, 432b and tracking coils 434a, 434b can be coiled into a rectangular or a circular shape. When a first current is conducted through tracking coils 434a, 434b, a first force created by the first current interacting with the first magnetic field will move the lens holder 410 which in turn leads actuator 400 to move along the tracking direction. When a second current is conducted through focusing coils 432a, 432b, a second force created by the second current interacting with the second magnetic field will move the lens holder 410 which in turn leads actuator 400 to move along the focusing direction; tracking coils 434a, 434b and focusing coils 432a, 432b will be placed on the same horizon as illustrated in FIG. 6.

Further, two fixing parts 442 can be placed respectively on two sides of lens holder 410; through these two fixing parts, metallic wires 440a, 440b, 440c, 440d can go through to keep lens holder 410 at a hanging status. Since metallic wires 440a, 440b, 440c, 440d must provide for current to be conducted in and out of the focusing coils 432a, 432b and the tracking coils 440c, 440d, the top and bottom planes of coiling device 430 can each form two bonding pads respectively for a total of four bonding pads 446a, 446b, 446c, 446d, to be connected to fixing part 442, respectively by the metallic wires 440a, 440b, 440c, 440d. As illustrated in the present invention, coiling device 430 comprises of two focusing coils 432a, 432b, and two tracking coils 434a, 434b. The first current can run through metallic wire 440a, bonding pad 446a, into first tracking coil 434a, and out of first tracking coil 434a, into second tracking coil 434b, out of second coil 434b to then run through bonding pad 446b and metallic wire 440b and finally out of actuator 100. By the same logic, the second current can run through metallic wire 440c, bonding pad 446c, into first focusing coil 432a, then out of first focusing coil 432a to run into second focusing coil 432b; after second current runs out of second focusing coil 432b it can then run through bonding pad 446d and metallic wire 440d and finally out of actuator 100. As shown in FIG. 6, since bonding pads 446c, 446d are positioned directly below bonding pads 446a, 446b, the dotted line of FIG. 6 represents the electric connection to bonding pads 446c, 446d, while the solid line represents electric connection to bonding pads 446a, 446b.

In order for lens holder 410 carrying lens 412 to move along focusing or tracking directions after currents are respectively conducted through focusing coils 432a, 432b and tracking coils 434a, 434b, the horizontal arrangement of the first and second magnets 422, 424 above and below lens holder 410 will be devised to have a plurality of magnetic areas having different polarities in response to the corresponding positions of the focusing coils 432a, 432b and tracking coils 434a, 434b.

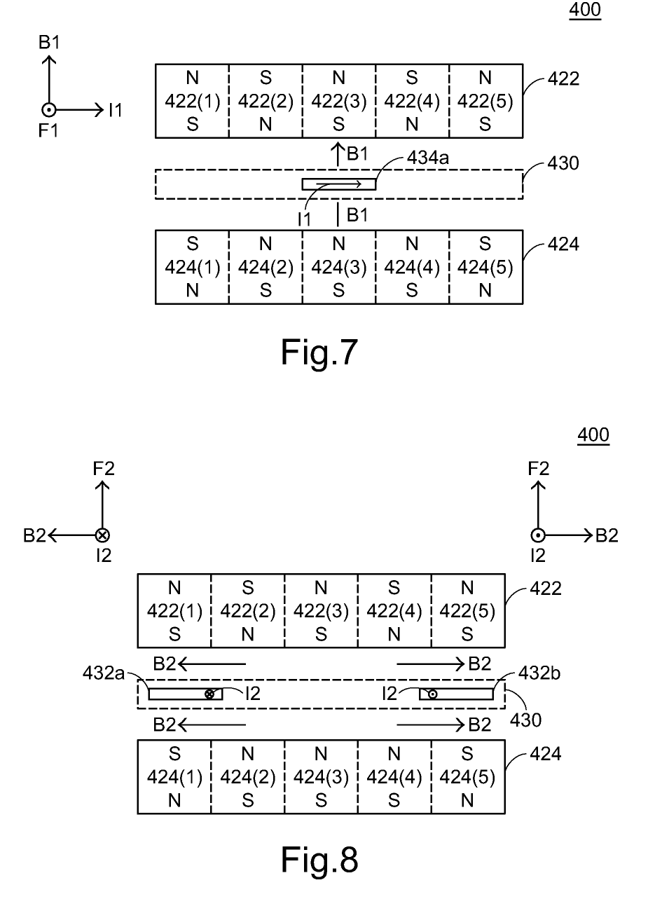

Please refer to FIG. 7, illustration of the first current being conducted through the tracking coils. When the design of coiling device 430 is as illustrated in FIG. 6, magnetic areas on the first magnet 422 can be divided into first magnetic area 442(1), second magnetic area 422(2), third magnetic area 422(3), forth magnetic area 422(4) and fifth magnetic area 422(5). Various magnetic areas in the second magnet are first magnetic area 424(1), second magnetic area 424(2), third magnetic area 424 (3), forth magnetic area 424 (4) and fifth magnetic area 424 (5). The various magnetic areas of first magnet 422 and second magnet 424 are designed in response to the corresponding positions of the focusing coils 432a, 432b and tracking coils 434a, 434b of coiling device 430.

A first polarity, such as S, is assigned to the magnetic areas neighboring to coiling device 430, of first magnetic area 422(1), third magnetic area 422(3), and fifth magnetic area 422(5) of first magnet 422 and first magnetic area 424(1) and fifth magnetic area 424(5) of second magnet 424. A second polarity, for instance N, is then assigned to the other magnetic areas neighboring to coiling device 430 including: second magnetic area 422(2) and forth magnetic area 422(4) of the first magnet 422, and second magnetic area 424(2), third magnetic area 424(3) and forth magnetic area 424 (4) of the second magnet.

By assigning, magnetic areas neighboring to coiling device 430, polarity of S on the third magnetic area 422(3) of first magnet 422 and polarity of N on the third magnetic area 424(3) of second magnet 424, the magnets can create a first magnetic field B1; the direction of such magnetic field B1 is perpendicular to the plane of coiling device 430 and the surface of the optical disk.

If first current I1 is conducted through tracking coils 434a, 434b, the first magnetic field will interact with first magnetic field B1 to form a first force F1. Since hanging apparatus 440 is keeping lens holder 410 at a hanging status, such first force F1 can enable lens holder 410 to move along the tracking direction.

Please refer to FIG. 8, illustration of second current being conducted through focusing coils. By the same logic, by assigning polarity of S to magnetic areas neighboring to coiling device 430 on first magnetic area 422(1), fifth magnetic area 422(5) of first magnet and first magnetic area 424(1), fifth magnetic area 424(5) of the second magnet 424, and assigning polarity of N to magnetic areas neighboring to coiling device 430 on second magnetic area 422(2), forth magnetic area 422(4) of the first magnet 422, and second magnetic area 424(2) and forth magnetic area 424(4) of the second magnet 424, the magnets form a second magnetic field B2; the direction of magnetic field B2 is parallel to the plane of the coiling device 430 and the surface of the optical disk.

When second current 12 is conducted through focusing coils 434a, 434b, under the influence of second magnetic field B2, actuator 400 will produce a second force F2 according to second current 12; second force F2 then prompts the lens holder 410 to move along focusing direction.

The perpendicular first and second forces will prompt lens holder to move along tracking or focusing direction in order to read or write information. The design of lens holder is not limited to the description of presently illustrated embodiment. The same effect can still be reached with an altered design of lens holder.

The present invention is intended to cover various modifications and similar arrangements included to within the spirit and scope of the appended claims, which are to be accorded with the broadest interpretation so as to encompass all such modifications and similar structures.

What is claimed is:

1. An actuator of an optical pickup head, comprising:
two magnetic elements;
a plurality of metallic wires;
a lens holder connected to the metallic wires for hanging the lens holder and located the lens holder between the two magnetic elements; and
a planar coiling device affixed on the lens holder and the coiling device including at least one focusing coil, at least one tracking coil and a plurality of separated bonding pads for electrically connecting to the metallic wires respectively; wherein two of the four bonding pads electrically connect to the at least one focusing coil and two bonding pads electrically connect to the at least one tracking coil.

2. The actuator according to claim 1, wherein the magnetic elements are magnets.

3. The actuator according to claim 2, wherein each magnet comprises a plurality of magnetic areas.

4. The actuator according to claim 1, wherein the planar coiling device is constructed by a print circuit board with a plurality of print circuit coils.

5. The actuator according to claim 1, wherein the planar coiling device is constructed by a plastic substrate with a plurality of fine pattern coils.

6. The actuator according to claim 1, wherein the at least one focusing coil and the at least one tracking coil are coiled into rectangular or circular shapes.

7. The actuator according to claim 1, wherein two bonding pads are located on each of the two surfaces of the planar coiling device.

8. An actuator of an optical pickup head, comprising:
a magnetic field producing apparatus including two magnetic elements;
a hanging device including a plurality of electrically conducting elements;
a lens holder connected to the hanging device for hanging the lens holder and located the lens holder between the two magnetic elements; and
a planar coiling device affixed on the lens holder and the coiling device including at least one focusing coil, at least one tracking coil and a plurality of separated bonding pads for connecting to the electrically conducting elements respectively; wherein two of the four bonding pads electrically connect to the at least one focusing coil and two bonding pads electrically connect to the at least one tracking coil.

9. The actuator according to claim 8, wherein the magnetic elements are magnets.

10. The actuator according to claim 9, wherein each magnet comprises a plurality of magnetic areas.

11. The actuator according to claim 8, wherein the planar coiling device is constructed by a print circuit board with a plurality of print circuit coils.

12. The actuator according to claim 8, wherein the planar coiling device is constructed by a plastic substrate with a plurality of fine pattern coils.

13. The actuator according to claim 8, wherein the at least one focusing coil and the at least one tracking coil are coiled into rectangular or circular shapes.

14. The actuator according to claim 8, wherein two bonding pads are located on each of the two surfaces of the planar coiling device.

15. The actuator according to claim 8, wherein the hanging device comprises a plurality of metallic wires or a plurality of leaf springs.
